(19) United States
(12) Patent Application Publication
(10) Pub. No.: US 2016/0259210 A1
(43) Pub. Date: Sep. 8, 2016

(54) LIQUID CRYSTAL DISPLAY AND MANUFACTURING METHOD THEREOF

(71) Applicant: Samsung Display Co., Ltd., Yongin-si (KR)

(72) Inventors: Young Min KIM, Yongin-si (KR); Min Ki NAM, Anseong-si (KR); Nam Seok ROH, Seongnam-si (KR); Ki Soo PARK, Hwaseong-si (KR); Hae Il PARK, Seoul (KR); Kwang Keun LEE, Osan-si (KR); Jun Han LEE, Incheon (KR)

(21) Appl. No.: 14/931,031

(22) Filed: Nov. 3, 2015

(30) Foreign Application Priority Data
Mar. 3, 2015 (KR) 10-2015-0029625

(51) Int. Cl. G02F 1/1335; G02F 1/1341; G02F 1/1333

(52) U.S. Cl. CPC G02F 1/133617; G02F 1/133528; G02F 1/133305; G02F 1/133377; G02F 1/133512; G02F 1/1341; G02F 2001/133614; G02F 2001/133548

(57) ABSTRACT

A liquid crystal display, including: a flexible substrate; a plurality of pixel electrodes formed on the substrate; a liquid crystal layer filled in a microcavity formed on the pixel electrode; a roof layer covering the microcavity; an overcoat sealing the microcavity; a flexible polarizer formed on the overcoat; and a color conversion layer formed on the polarizer, wherein the color conversion layer includes a plurality of color conversion media layers formed at a position corresponding to the microcavity, and upper light blocking members formed between the color conversion media layers to partition the color conversion media layers. The liquid crystal display has good color reproducibility and flexibility by forming the flexible wire grid polarizer and the color conversion media (CCM) on the surface of the liquid crystal display manufactured with one substrate.

### CROSS-REFERENCE TO RELATED APPLICATION

This application claims priority to and the benefit of Korean Patent Application No. 10-2015-0029625 filed in the Korean Intellectual Property Office on Mar. 3, 2015, the entire contents of which are incorporated herein by reference.

### BACKGROUND

(a) Field

The present invention relates to a liquid crystal display (LCD) and a manufacturing method thereof.

(b) Description of the Related Art

Presently, liquid crystal display (LCD) is one of the most widely used flat panel displays. A liquid crystal display (LCD) includes two display panels on which field generating electrodes such as a pixel electrode and a common electrode are formed, and a liquid crystal layer is interposed between the two display panels.

Among the various liquid crystal displays, a liquid crystal display that is commonly used has a structure in which an electric field generation electrode is provided in each of the two display panels. Among the two display panels, a plurality of pixel electrodes and thin film transistors are arranged in a matrix format on one display panel (hereinafter referred to as “a thin film transistor array panel”), and color filters of red, green, and blue are formed on the other display panel, and one common electrode covers the entire surface of the other display panel (hereinafter referred to as “a common electrode panel”).

However, such liquid crystal display generates light loss in the polarizers and the color filters. To reduce the light loss and realize a liquid crystal display of high efficiency, a photo-luminescent liquid crystal display (PL-LCD) applied with a color conversion material instead of the color filters has been proposed.

The PL-LCD uses a color conversion media (CCM) instead of color filters. In a PL-LCD, when light emitted from a light source is supplied to the color conversion media, some of the light emitted from the light source diffuses or propagates at an angle and becomes supplied to adjacent pixels. Such a phenomenon is called optical crosstalk, which causes deterioration of color reproducibility.

The above information disclosed in this Background section is only to enhance the understanding of the background of the invention, and therefore it may contain information that does not form the prior art that is already known in this country to a person of ordinary skill in the art.

### SUMMARY

A liquid crystal display that has good color reproducibility and a manufacturing method thereof are presented. Flexibility may be provided in the liquid crystal display by forming a flexible wire grid polarizer and color conversion media (CCM) on the surface of the liquid crystal display manufactured with one substrate.

An exemplary embodiment provides a liquid crystal display, including: a flexible substrate; a plurality of pixel electrodes formed on the substrate; a liquid crystal layer filled in a microcavity formed on the pixel electrode; a roof layer covering the microcavity; an overcoat sealing the microcavity; a flexible polarizer formed on the roof layer; and a color conversion layer formed on the flexible polarizer, wherein the color conversion layer includes a plurality of color conversion media layers formed at a position aligned with the microcavity, and upper light blocking members formed between the color conversion media layers to partition the color conversion media layers.

The flexible polarizer may be attached to the overcoat, and the color conversion layer may be attached to the flexible polarizer.

Lower light blocking members aligned with areas between the plurality of pixel electrodes may be further included.

The color conversion media layer may include a phosphor or a quantum dot.

The lower light blocking member and the upper light blocking members may be aligned with and overlap each other.

The color conversion media layer may include a red color conversion media layer and a green conversion media layer.

The color conversion media layer may include a transparent layer disposed in the same layer where the red color conversion media layer and the green conversion media layer are disposed.

A backlight assembly including a blue light emitting diode (LED) emitting blue light may be further included.

The color conversion media layer may include a blue color conversion media layer.

The polarizer may be a wire grid polarizer.

The wire grid polarizer may include a flexible polarization substrate and a metal lattice formed on the flexible polarization substrate.

A portion of the metal lattice corresponding to the color conversion media layer may be formed in a first pattern, and a portion of the metal lattice corresponding to the upper light blocking members may be formed in a second pattern different from the first pattern.

The metal lattice may be formed in a region corresponding to the color conversion media layer, and the metal lattice may be formed in a first pattern that includes thin solid portions.

The polarizer may include a metal lattice, and the metal lattice contacts an upper portion of the overcoat.

The metal lattice may be formed only at a position overlapping with the color conversion media layer.

In another aspect, the present disclosure provides a manufacturing method of a liquid crystal display, including: forming a plurality of pixel electrodes on a flexible substrate, and lower light blocking members between the plurality of pixel electrodes; sequentially forming a sacrificial layer and roof layer on the pixel electrodes; forming a microcavity by partially etching the roof layer and removing the sacrificial layer; forming a liquid crystal layer by filling a liquid crystal material in the microcavity; forming an overcoat sealing the microcavity holding the liquid crystal layer; forming a flexible polarizer on the overcoat; forming upper light blocking members at a position overlapped with the lower light blocking members on the polarizer; and forming a color conversion layer by forming a color conversion media layer including a phosphor or a quantum dot between the upper light blocking member.

The liquid crystal display according to the embodiment of the present invention has good color reproducibility, and flexibility may be provided by forming the flexible wire grid polarizer and the color conversion media (CCM) on the surface of the liquid crystal display manufactured with one substrate.

### BRIEF DESCRIPTION OF THE DRAWINGS

FIG. 1 is a top plan view of a liquid crystal display according to an exemplary embodiment of the inventive concept.

FIG. 2 is a cross-sectional view of FIG. 1 taken along line II-II.

FIG. 3 is a cross-sectional view of a liquid crystal display according to another exemplary embodiment of the inventive concept.

FIGS. 4, 5, and 6 are cross-sectional views sequentially illustrating a manufacturing method of a liquid crystal display according to an exemplary embodiment of the inventive concept.

### DETAILED DESCRIPTION OF THE EMBODIMENTS

The present inventive concept will be described more fully hereinafter with reference to the accompanying drawings, in which exemplary embodiments are shown. As those skilled in the art would realize, the described embodiments may be modified in various different ways, all without departing from the spirit or scope of the inventive concept.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

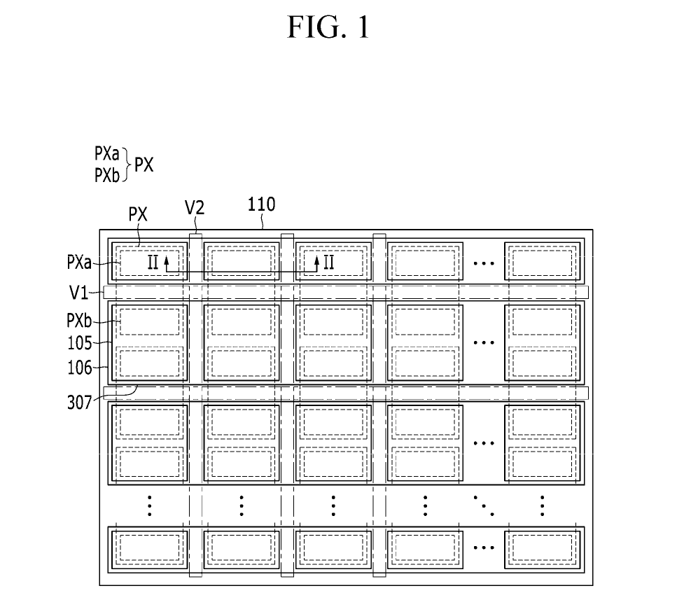

A liquid crystal display according to an exemplary embodiment of the present disclosure will now be described in detail with reference to FIG. 1.

FIG. 1 is a top plan view of a liquid crystal display according to an exemplary embodiment of the present invention, and for convenience, only some constituent elements are illustrated in FIG. 1.

A liquid crystal display according to an exemplary embodiment includes a flexible substrate 110 made of a material such as plastic, a polymer, or the like, and a roof layer 106 formed on the substrate 110.

The substrate 110 includes a plurality of pixels PX. In the specification, the term “pixel(s) PX” may include or stand for “pixel area(s).”

The pixels PX are disposed in a matrix configuration that includes a plurality of pixel rows and a plurality of pixel columns. Each pixel PX may include a first subpixel PXa and a second subpixel PXb. The first subpixel PXa and the second subpixel PXb may be disposed in the column direction.

A first valley V1 is disposed between the first subpixel PXa and the second subpixel PXb and extends in a pixel row direction, and a second valley V2 extends in the column direction, between a plurality of pixel columns.

The roof layer 106 may be formed in the plurality of pixel rows. In this case, the roof layer 106 is removed from the first valley V1, and thus an injection hole (not shown) is formed so that constituent elements disposed below the roof layer 106 may be exposed to the outside.

Each roof layer 106 is formed between adjacent second valleys V2, such that a microcavity 105 is between the roof layer 106 and the substrate 110. Each roof layer 106 is formed in the second valley V2 such that it fills the distance between microcavities and covers lateral surfaces of the microcavity 105.

The structure of the liquid crystal display according to the exemplary embodiment described above is just an example, and may be modified. For example, arrangement of the pixel PX, the first valley V1, and the second valley V2 may be modified, the roof layers 106 may be connected to each other in the first valley V1, and each roof layer 106 may be formed to be partially spaced apart from the substrate 110 in the second valley V2 such that the adjacent microcavities 105 may be connected to each other.

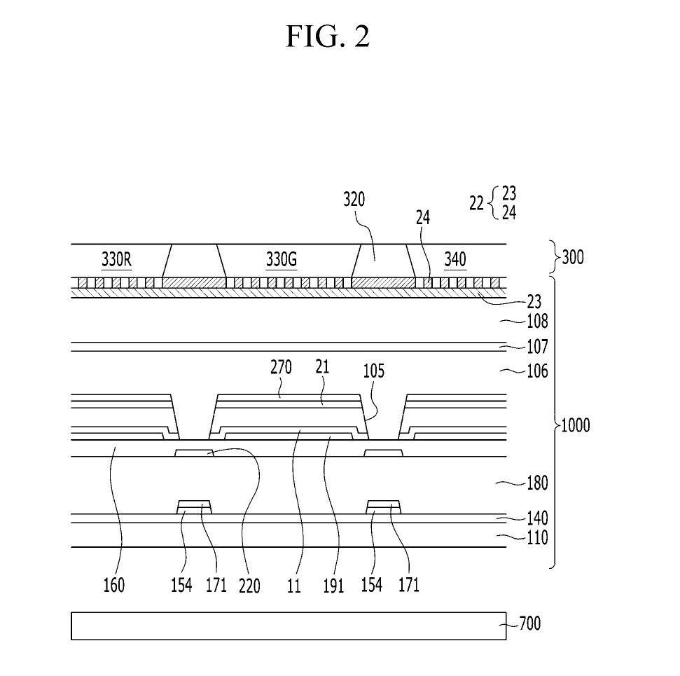

The liquid crystal display according to the exemplary embodiment of the inventive concept will now be described more fully with reference to FIG. 2.

FIG. 2 is a cross-sectional view of FIG. 1 taken along line II-II.

Referring to FIG. 2, a liquid crystal panel 1000 includes the flexible substrate 110 made of a material such as plastic, a polymer, or the like, a plurality of gate lines (not shown), a plurality of semiconductors 154, a plurality of data lines 171, and a passivation layer 180.

A plurality of lower light blocking members 220 and an interlayer insulating layer 160 are disposed on the passivation layer 180. The lower light blocking members 220 cover the data lines 171. The interlayer insulating layer 160 covers the lower light blocking members 220, and an upper surface of the interlayer insulating layer 160 is flattened.

A pixel electrode 191 is disposed on the interlayer insulating layer 160, a first alignment layer 11 is disposed on the pixel electrode 191, a second alignment layer 21 is provided in a region that faces the first alignment layer 11, and a microcavity 305 is provided between the first alignment layer 11 and the second alignment layer 21.

A liquid crystal material including liquid crystal molecules is injected into the microcavity 105, and the microcavity 105 includes a liquid crystal injection hole (not shown) into which the liquid crystal material is injected. The liquid crystal injection hole (not shown) may be disposed on a lateral surface of the microcavity 105.

A common electrode 270 is disposed on the second alignment layer 21. The common electrode 270 receives a common voltage, and generates an electric field together with the pixel electrode 191 to which a data voltage is applied, thereby determining an inclined direction of the liquid crystal molecules contained in the microcavity 105 between the two electrodes 270 and 191. The common electrode 270 forms a capacitor with the pixel electrode 191 and maintains a voltage applied thereto after a thin film transistor is turned off.

The common electrode 270 is disposed on the microcavity 105 in the present exemplary embodiment, but this is not a limitation of the inventive concept. For example, the common electrode 270 may be disposed below the microcavity 305 to enable liquid crystal driving depending on a coplanar electrode (CE) mode.

A roof layer 106 is disposed on the common electrode 270. The roof layer 106 plays a part in the formation of the microcavity 105, which is formed in a space between the pixel electrode 191 and the common electrode 270. The roof layer 106 may include a photoresist or other organic materials.

An insulating layer 107 made of a silicon nitride (SiNx) or a silicon oxide (SiOx) is disposed on the roof layer 106, and a capping layer 108 is disposed on the insulating layer 107.

The overcoat 108 covers the liquid crystal injection hole of the microcavity 105 exposed while filling a portion where the liquid crystal injection hole (not shown) is formed. The overcoat 108 includes an organic material or an inorganic material.

A polarizer 22 is disposed on the overcoat 108.

The polarizer 22 may be a wire grid polarizer formed of a flexible material, but is not limited thereto, and may be other polarizers formed of the flexible material.

The wire grid polarizer may include a metal lattice 24 disposed on the flexible polarization substrate 23, and the flexible polarization substrate 23 may be formed of polyimide (PI) and the metal lattice 24 may be formed of one or more selected from aluminum (Al), silver (Ag), and chromium (Cr), but are not limited thereto. In addition, in the alternative, a metal lattice 24 may be directly formed on the overcoat 108 by forming an overcoat 108 having a shape of the wire grid polarizer as the polarization substrate 23 on the overcoat 108.

The metal lattice 24 is densely formed in a minute pattern at a portion thereof corresponding to or aligned with the color conversion media layers 330R, 330G, 330B and the transparent layer 340. A large pattern of the metal lattice 24 may be formed at a portion corresponding to areas between the color conversion media layers 330R/G/B and the transparent layer 340, or the area aligned with the upper light blocking members 320.

In other words, the pattern of the metal lattice 24 in areas covering the microcavity 105 (the first pattern) may be different from the pattern of the metal lattice 24 in areas that cover the portion between microcavities (the second pattern). More specifically, the metal lattice 24 may be formed in a pattern with thinner/narrower sections at the portion corresponding to the microcavity 105, and may be formed in one large/wide solid pattern at the portion corresponding to the lower light blocking members 220.

The metal lattice 24 may be formed as a wide solid piece at a portion between the lower light blocking members 220 and the upper light blocking members 320 to block light together with the first and upper light blocking members 220 and 320. In some embodiments, the large-patterned portion of the metal lattice 24 may be aligned with one, instead of both, of the lower light blocking members 220 and the upper light blocking members 320.

In some embodiments, the metal lattice 24 may not be formed in a region overlapped with the lower light blocking members 220. This is because a polarization process is not required by the metal lattice 24 since light emitted from a backlight assembly 700 does not transmit through a region in which the lower light blocking members 220 are formed.

A color conversion layer 300 is formed above the polarizer 22.

The color conversion layer 300 includes a plurality of upper light blocking members 320, a plurality of red color conversion media layers 330R, a plurality of green color conversion media layers 330G, and a plurality of transparent layers 340.

The color conversion layer 300 contacts an upper surface of the polarizer 22.

Here, each of the upper light blocking members 320 overlaps each of the lower light blocking members 220. In addition, each of the upper light blocking members 320 partitions the red color conversion media layer 330R, the green color conversion media layer 330G, and the transparent layer 340. The red color conversion media layer 330R, the green color conversion media layer 330G, and the transparent layer 340 are disposed between the upper light blocking members 320.

The red color conversion media layer 330R converts blue light supplied from the backlight assembly 700 to red light. The red color conversion media layer 330R may be formed of a red phosphor, and at least one of (Ca, Sr, Ba)S, (Ca, Sr, Ba)₂Si₅N₈, CaAlSiN₃, CaMoO₄, and Eu₂Si₅N₈ may be used as the red phosphor.

The green color conversion media layer 330G converts blue light supplied from the backlight assembly 700 to green light. The green color conversion media layer 330G is formed of a green phosphor, and at least one of yttrium aluminum garnet (YAG), (Ca, Sr, Ba)₂SiO₄, SrGa₂S₄, BAM, α-SiAlON, β-SiAlON, Ca₃Sc₂Si₃O₁₂, Tb₃Al₅O₁₂, BaSiO₄, and CaAlSiON, and (Sr₁₋ₓBaₓ)Si₂O₂N₂ may be used as the green phosphor.

In addition, the red color conversion media layer 330R and the green color conversion media layer 330G may be formed of quantum dots, a color of which changes according to the size.

The quantum dot may be selected from a Group II-VI compound, a Group IV-VI compound, a Group IV element, a Group IV compound, and a combination thereof.

The group II-VI compound may be selected from: a group of two-element compounds selected from CdSe, CdTe, ZnS, ZnSe, ZnTe, ZnO, HgS, HgSe, HgTe,

MgSe, MgS, and a mixture thereof; a group of three-element compounds selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and a mixture thereof; and a group of four-element compounds selected from HgZnTeS, CdZnSeS, CdZnSeTe, CdZnSTe, CdHgSeS, CdHgSeTe, CdHgSTe, HgZnSeS, HgZnSeTe, HgZnSTe, and a mixture thereof. A group III-V compound may be selected from: a group of two-element compounds selected from GaN, GaP, GaAs, GaSb, AN, AlP, AlAs, AlSb, InN, InP, InAs, InSb, and a mixture thereof; a group of three-element compounds selected from GaNP, GaNAs, GaNSb, GaPAs, GaPSb, AlNP, AlNAs, AlNSb, AlPAs, AlPSb, InNP, InNAs, InNSb, InPAs, InPSb, GaAlNP, and a mixture thereof; and a group of four-element compounds selected from GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, and a mixture thereof. The group IV-VI compound may be selected from: a group of two-element compounds selected from SnS, SnSe, SnTe, PbS, PbSe, PbTe, and a mixture thereof; a group of three-element compounds selected from SnSeS, SnSeTe, SnSTe, PbSeS, PbSeTe, PbSTe, SnPbS, SnPbSe, SnPbTe, and a mixture thereof; and a group of four-element compounds selected from SnPbSSe, SnPbSeTe, SnPbSTe, and a mixture thereof. The group IV element may be selected from a group of Si, Ge, and a mixture thereof. The group IV compound may be a two-element compound selected from a group of SiC, SiGe, and a mixture thereof.

In this case, the binary compound, the tertiary compound, or the quaternary compound may be present in particles in uniform concentrations, or may have partially different concentrations in the same particle, respectively. In addition, a core/shell structure in which some quantum dots enclosing some other quantum dots may be possible. An interfacing surface between the core and the shell may have a concentration gradient in which a concentration of an element decreases closer to its center.

The quantum dots may have a full width at half maximum (FWHM) of a light-emitting wavelength spectrum of about 45 nm or less, preferably about 40 nm or less, and more preferably about 30 nm or less. In the quantum dots having the FWHM, the color purity or color reproducibility may be improved.

In addition, shapes of the quantum dots are not specifically limited to shapes that are generally used in the related art, but more specifically, it is desirable that a nanoparticle having a spherical, pyramidal, multi-arm, or cubic shape, and a nanotube, a nanowire, a nanofiber, and a planar nanoparticle are used.

The transparent layer 340 may be made of transparent polymer, and blue light supplied from the backlight assembly 700 is passed through the transparent layer 340 such that a blue color is displayed. The transparent layer 340 may include a plurality of pores that diffuse the blue light supplied from the backlight assembly 700.

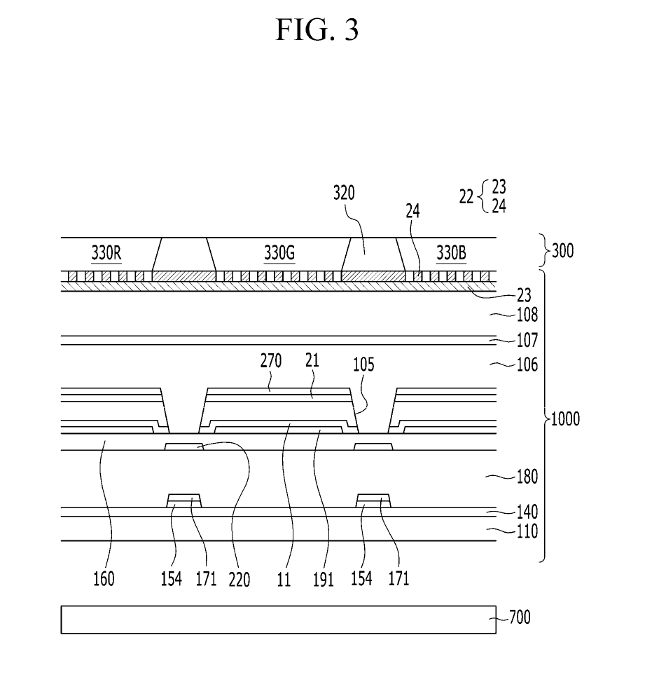

A liquid crystal display according to another exemplary embodiment will now be described in detail with reference to FIG. 3.

FIG. 3 is a cross-sectional view of a liquid crystal display according to another exemplary embodiment of the inventive concept.

The exemplary embodiment shown in FIG. 3 is substantially the same as the exemplary embodiment shown in FIG. 2, except for the color conversion layer 300. Thus, redundant description thereof will not be provided.

The color conversion layer 300 includes a plurality of upper light blocking members 320, a plurality of red color conversion media layers 330R, a plurality of green color conversion media layers 330G, and a plurality of blue color conversion media layers 330B.

The color conversion layer 300 contacts the upper surface of the polarizer 22.

Here, each of the upper light blocking members 320 overlaps each of the lower light blocking members 220. In addition, each of the upper light blocking members 320 partitions an area where the red color conversion media layer 330R, the green color conversion media layer 330G, and the blue color conversion media layer 330B are disposed, and the red color conversion media layer 330R, the green color conversion media layer 330G, and the blue color conversion media layer 330B are disposed between the upper light blocking members 320.

The red color conversion media layer 330R may be formed of a red phosphor, and at least one of Y₂O₂S, La₂O₂S, (Ca, Sr, Ba)₂Si₅N₈, CaAlSiN₃, (La, Eu)₂W₃O₁₂, (Ca, Sr, Ba)₃MgSi₂O₈, and Li(Eu, Sm)W₂O₈ is used as the red phosphor. The red phosphor receives ultraviolet rays, emits red light, and diffuses the red light.

The green color conversion media layer 330G is formed of a green phosphor, and at least one of (Ca, Sr, Ba)₂SiO₄, BAM, α-SiAlON, Ca₃Sc₂Si₃O₁₂, Tb₃Al₅O₁₂, and LiTbW₂O₈ is used as the green phosphor. The green phosphor receives ultraviolet rays, emits green light, and diffuses the green light.

The blue color conversion media layer 330B is formed of a blue phosphor, and at least one of BaMgAl₁₀O₁₇, (Mg, Ca, Sr, Ba)₅PO₄₃Cl, EuSi₉Al₁₉ON₃₁, and La₁₋ₓCeₓAl (Si_{6-z}Al_{z})(N_{10-z}O_{z}) is used as the blue phosphor. The blue phosphor receives ultraviolet rays, emits blue light, and diffuses the blue light.

In addition, the red color conversion media layer 330R, the green color conversion media layer 330G, and the blue color conversion media layer 330B may be formed of quantum dots, a color of which is changed according to the size.

The quantum dot may be selected from a Group II-VI compound, a Group IV-VI compound, a Group IV element, a Group IV compound, and a combination thereof.

The group II-VI compound may be selected from: a group of two-element compounds selected from CdSe, CdTe, ZnS, ZnSe, ZnTe, ZnO, HgS, HgSe, HgTe, MgSe, MgS, and a mixture thereof; a group of three-element compounds selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and a mixture thereof; and a group of four-element compounds selected from HgZnTeS, CdZnSeS, CdZnSeTe, CdZnSTe, CdHgSeS, CdHgSeTe, CdHgSTe, HgZnSeS, HgZnSeTe, HgZnSTe, and a mixture thereof. A group III-V compound may be selected from: a group of two-element compounds selected from GaN, GaP, GaAs, GaSb, AN, AlP, AlAs, AlSb, InN, InP, InAs, InSb, and a mixture thereof; a group of three-element compounds selected from GaNP, GaNAs, GaNSb, GaPAs, GaPSb, AlNP, AlNAs, AlNSb, AlPAs, AlPSb, InNP, InNAs, InNSb, InPAs, InPSb, GaAlNP, and a mixture thereof; and a group of four-element compounds selected from GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, and a mixture thereof. The group IV-VI compound may be selected from: a group of two-element compounds selected from SnS, SnSe, SnTe, PbS, PbSe, PbTe, and a mixture thereof; a group of three-element compounds selected from SnSeS, SnSeTe, SnSTe, PbSeS, PbSeTe, PbSTe, SnPbS, SnPbSe, SnPbTe, and a mixture thereof; and a group of four-element compounds selected from SnPbSSe, SnPbSeTe, SnPbSTe, and a mixture thereof. The group IV element may be selected from a group of Si, Ge, and a mixture thereof. The group IV compound may be a two-element compound selected from a group of SiC, SiGe, and a mixture thereof.

In this case, the binary compound, the tertiary compound, or the quaternary compound may be present in particles in uniform concentrations, or may have partially different concentrations in the same particle, respectively. In addition, a core/shell structure in which some quantum dots enclosing some other quantum dots may be possible. An interfacing surface between the core and the shell may have a concentration gradient in which a concentration of an element decreases closer to its center.

The quantum dots may have a full width at half maximum (FWHM) of a light-emitting wavelength spectrum of about 45 nm or less, preferably about 40 nm or less, and more preferably about 30 nm or less. In the quantum dots having the FWHM, the color purity or color reproducibility may be improved.

In addition, shapes of the quantum dots are not specifically limited to shapes that are generally used in the related art, but more specifically, it is desirable that a nanoparticle having a spherical, pyramidal, multi-arm, or cubic shape, and a nanotube, a nanowire, a nanofiber, and a planar nanoparticle are used.

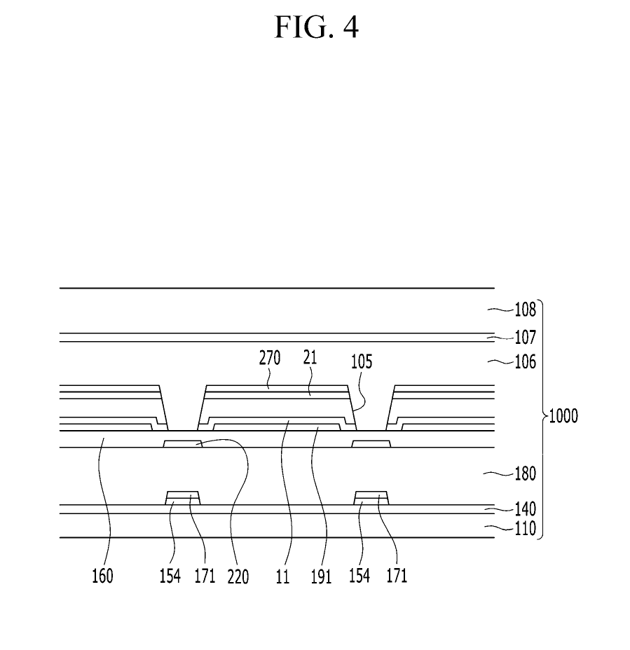

Hereinafter, a manufacturing method of a liquid crystal display according to an exemplary embodiment will be sequentially described with reference to FIGS. 4 to 6.

FIGS. 4 to 6 are cross-sectional views sequentially illustrating a manufacturing method of a liquid crystal display according to an exemplary embodiment.

First, referring to FIG. 4, a plurality of gate lines (not shown) are formed on a flexible substrate 110 made of a material such as plastic, a polymer, or the like, and a gate insulation layer 140 is formed on an entire surface of the substrate 110 including the gate lines.

Next, a semiconductor material such as amorphous silicon, polycrystalline silicon, and a metal oxide is deposited on the gate insulating layer 140, and the deposited semiconductor material is patterned for a semiconductor 150 to be formed.

Next, a data line 171 extending in the other direction is formed by depositing a metal material and then patterning the deposited metal material, and source and drain electrodes (not shown) protruding from the data line 171 are formed, such that a thin film transistor (TFT) is formed.

A passivation layer 180 may be formed with an organic insulating material or an inorganic insulating material on the semiconductor 154 and the data line 171, and the passivation layer 180 may be formed as a single layer or multiple layers.

Next, lower light blocking members 220 are formed at a boundary portion of each pixel PX on the passivation layer 180, and are formed on thin film transistor. The lower light blocking members 220 may be further formed at a first valley V1 disposed between a first subpixel (PXa) and a second subpixel (PXb).

An interlayer insulating layer 160 is formed on the lower light blocking members 220, and the interlayer insulating layer 160 may be made of an inorganic insulating material, such as a silicon nitride (SiNx), a silicon oxide (SiOx), and a silicon nitride oxide (SiOxNy).

A pixel electrode 191 is formed by depositing a transparent metal material such as indium tin oxide (ITO) and indium zinc oxide (IZO) on the interlayer insulating layer 160 and then patterning the deposited transparent metal.

A sacrificial layer (not shown) is formed by coating a photosensitive organic material on the pixel electrode 191 and performing a photolithography process, and a common electrode 270 and a roof layer 106 are formed by depositing a transparent metal material such as indium tin oxide (ITO) and indium zinc oxide (IZO) on the sacrificial layer.

The common electrode 270 may be patterned by using the roof layer 106 as a mask, and an insulating layer 107 may be formed with an inorganic insulating material such as a silicon nitride (SiNx), a silicon oxide (SiOx), and a silicon nitride oxide (SiOxNy) on the roof layer 106.

The sacrificial layer (not shown) is completely removed by supplying a developer or a striper solution on the substrate 110 where the sacrificial layer (not shown) is exposed, or by using an ashing process, such that a microcavity 105 is formed.

Next, first and second alignment layers 11 and 21 are formed by injecting an aligning agent, and the microcavity 105 is sealed by forming an overcoat 108 after injecting a liquid crystal material into the microcavity 105, such that a liquid crystal panel 1000 is completed.

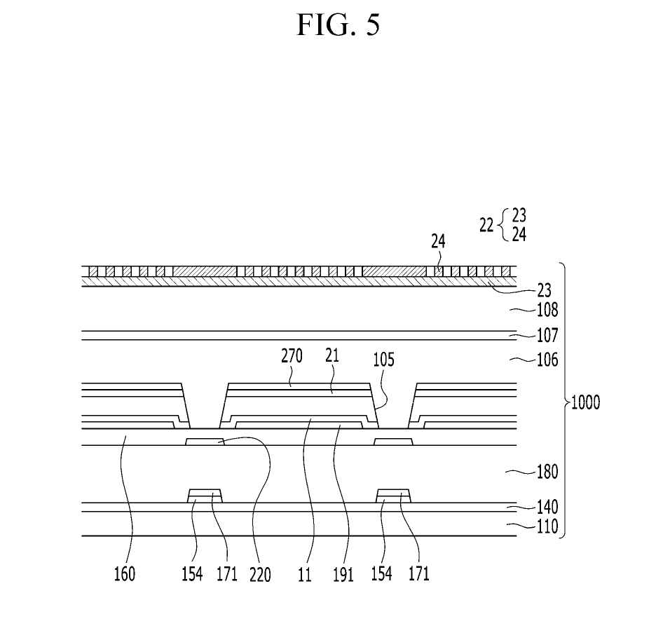

Next, referring to FIG. 5, a polarizer 22 is formed on a surface of the liquid crystal panel 1000.

The polarizer 22 may be a flexible polarizer, for example, it may be a wire grid polarizer, but it is not limited thereto, and it may be other polarizers including the flexible material.

When the polarizer 22 is the wire grid polarizer, the wire grid polarizer may include a metal lattice 24 disposed on the flexible polarization substrate 23, and the flexible polarization substrate 23 may be formed of polyimide (PI) and the metal lattice 24 may be formed of one or more selected from aluminum (Al), silver (Ag), and chromium (Cr), but are not limited thereto. The wire grid polarizer may be formed by methods well known to those skilled in the art, for example, by the imprinting method or the block copolymer method. In addition, in the alternative, a metal lattice 24 may be directly formed on the overcoat 108 by forming an overcoat 108 having a shape of the wire grid polarizer as the polarization substrate 23 on the overcoat 108.

The metal lattice 24 is formed in a minute pattern (the first pattern) at a portion thereof corresponding to the color conversion media layers 330R, 330G, and 330B, and the transparent layer 340, and is formed as one large piece (the second pattern) at a portion thereof corresponding to the upper light blocking members 320.

In other words, the pattern of the metal lattice 24 in areas covering the microcavity 105 may be different from the pattern of the metal lattice 24 in areas that cover the portion between microcavities. More specifically, the metal lattice 24 may be formed in a pattern with thinner/narrower sections at the portion corresponding to the microcavity 105, and may be formed in one large/wide pattern at the portion corresponding to the lower light blocking members 220.

The metal lattice 24 may be formed as a wide solid piece at a portion between the lower light blocking members 220 or the upper light blocking members 320 to block light together with the first and upper light blocking members 220 and 320. In some embodiments, the large-patterned portion of the metal lattice 24 may be aligned with one, instead of both, of the lower light blocking members 220 and the upper light blocking members 320.

In some embodiments, the metal lattice 24 may not be formed in a region overlapped with the lower light blocking members 220. This is because a polarization process is not required by the metal lattice 24 since light emitted from a backlight assembly 700 does not transmit through a region in which the lower light blocking members 220 are formed.

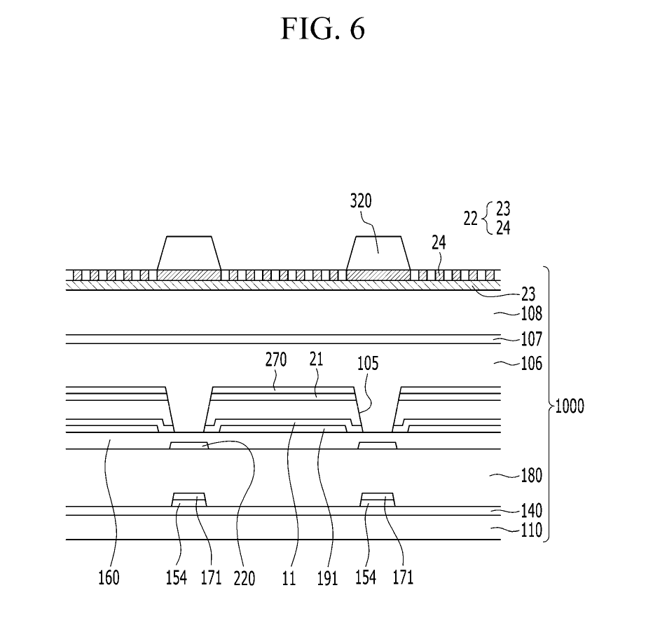

Next, referring to FIG. 6, the upper light blocking members 320 are formed on the polarizer 22, and the red color conversion media layer 330R, the green color conversion media layer 330G, and the transparent layer 340 are respectively formed between the upper light blocking members 320, and as a result, the liquid crystal display according to the present exemplary embodiment shown in FIG. 6 is completed.

As described above, the liquid crystal display according to the exemplary embodiments has good color reproducibility and flexibility may be provided by forming the flexible wire grid polarizer and the color conversion media (CCM) on the surface of the liquid crystal display manufactured with one substrate.

While this disclosure has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims and the disclosure above.

### DESCRIPTION OF SYMBOLS

| | |
|---|---|
| 110: substrate | 140: gate insulating layer |
| 154: semiconductor | 171: data line |
| 180: passivation layer | 220, 320: first, second light blocking member |

| | |
|---|---|
| 160: interlayer insulating layer | 191: pixel electrode |
| 11, 21: first, second alignment layer | 270: common electrode |

| | |
|---|---|
| 105: microcavity | 106: roof layer |

| | |
|---|---|
| 107: insulating layer | 108: overcoat |
| 22: polarizer | 1000: liquid crystal panel |

| | |
|---|---|
| 300: color conversion layer | 340: transparent layer |

330R, 330G, 330B: red, green and blue color conversion media layer

What is claimed is:

1. A liquid crystal display, comprising:
a flexible substrate;
a plurality of pixel electrodes formed on the substrate;
a liquid crystal layer filled in a microcavity formed on the pixel electrode;
a roof layer covering the microcavity;
an overcoat sealing the microcavity;
a flexible polarizer formed on the overcoat; and
a color conversion layer formed on the flexible polarizer,
wherein the color conversion layer includes a plurality of color conversion media layers formed at a position aligned with the microcavity, and
upper light blocking members formed between the color conversion media layers to partition the color conversion media layers.

2. The liquid crystal display of claim 1, wherein
the flexible polarizer is attached to the overcoat, and
the color conversion layer is attached to the flexible polarizer.

3. The liquid crystal display of claim 2, further comprising
lower light blocking members aligned with areas between the plurality of pixel electrodes.

4. The liquid crystal display of claim 3, wherein
the color conversion media layer includes a phosphor or a quantum dot.

5. The liquid crystal display of claim 4, wherein
the lower light blocking member and the upper light blocking members are aligned with and overlap each other.

6. The liquid crystal display of claim 4, wherein
the color conversion media layer includes a red color conversion media layer and a green conversion media layer.

7. The liquid crystal display of claim 6, wherein
the color conversion media layer includes a transparent layer disposed in the same layer where the red color conversion media layer and the green conversion media layer are disposed.

8. The liquid crystal display of claim 7, further comprising
a backlight assembly including a blue light emitting diode (LED) emitting blue light.

9. The liquid crystal display of claim 6, wherein
the color conversion media layer includes a blue color conversion media layer.

10. The liquid crystal display of claim 2, wherein
the polarizer is a wire grid polarizer.

11. The liquid crystal display of claim 10, wherein
the wire grid polarizer includes a flexible polarization substrate, and
a metal lattice formed on the flexible polarization substrate.

12. The liquid crystal display of claim 11, wherein
a portion of the metal lattice corresponding to the color conversion media layer is formed in a first pattern, and
a portion of the metal lattice corresponding to the upper light blocking members is formed in a second pattern different from the first pattern.

13. The liquid crystal display of claim 11, wherein
the metal lattice is formed in a region corresponding to the color conversion media layer in a first pattern that includes thin solid portions.

14. The liquid crystal display of claim 10, wherein
the polarizer includes a metal lattice, and
the metal lattice contacts an upper portion of the overcoat.

15. The liquid crystal display of claim 14, wherein
the metal lattice is formed only at a position overlapping with the color conversion media layer.

16. A manufacturing method of a liquid crystal display, comprising:
forming a plurality of pixel electrodes on a flexible substrate and lower light blocking members between the plurality of pixel electrodes;
sequentially forming a sacrificial layer and roof layer on the pixel electrodes;
forming a microcavity by partially etching the roof layer and removing the sacrificial layer;
forming a liquid crystal layer by filling a liquid crystal material in the microcavity;
forming an overcoat sealing the microcavity holding the liquid crystal layer; forming a flexible polarizer on the roof layer;
forming upper light blocking members at a position overlapping with the lower light blocking members on the polarizer; and
forming a color conversion layer by forming a color conversion media layer including a phosphor or a quantum dot between the upper light blocking members.

17. The manufacturing method of claim 16, further comprising:
forming a red color conversion media layer and a green conversion media layer included in the color conversion media layer; and
forming a transparent layer or a blue color conversion media layer to be disposed in the same layer where the red color conversion media layer and the green conversion media layer are disposed.

18. The manufacturing method of claim 17, wherein
the polarizer is a wire grid polarizer.

19. The manufacturing method of claim 18, wherein the forming of the polarizer comprises:
forming a metal lattice on the overcoat.

20. The manufacturing method of claim 18, wherein
the forming of the polarizer includes
forming a flexible substrate on the overcoat; and
forming a metal lattice on the flexible substrate.
